(19) United States
(12) Patent Application Publication
(10) Pub. No.: US 2020/0196676 A1
(43) Pub. Date: Jun. 25, 2020

(54) HEATING ELEMENTS AND DUAL-USE ELECTRONIC CIGARETTES HAVING THE HEATING ELEMENTS

(71) Applicant: SHENZHEN KANGER TECHNOLOGY CO., LTD., SHENZHEN (CN)

(72) Inventor: XIAOCHUN ZHU, SHENZHEN (CN)

(73) Assignee: SHENZHEN KANGER TECHNOLOGY CO., LTD., SHENZHEN (CN)

(21) Appl. No.: 16/231,989

(22) Filed: Dec. 25, 2018

(51) Int. Cl. A24F 47/00; A24F 7/00; A24B 15/16; H05B 3/26

(52) U.S. Cl. CPC A24F 47/008; H05B 3/26; A24B 15/167; A24F 7/00

(57) ABSTRACT

Present disclosure relates to ceramic heating elements and dual-use electronic cigarettes having the ceramic heating elements. In certain embodiments, the dual-use electronic cigarette includes: a mouthpiece and a dual-use vaporizer assembly having a vaporizer upper body connected to a mouthpiece, a vaporizer middle body connected to the vaporizer upper body through a vaporizer connector, a vaporizer power connector assembly connected to the vaporizer middle body, and a heater. The heater includes a bottom heater for vaporizing tobacco wax and a perimeter heater for heating tobacco leaf. When a user places a predetermined amount of tobacco wax in the bottom heater or a predetermined amount of tobacco leaf in the perimeter heater, places the corresponding heater into the dual-use vaporizer assembly, and connects an external electrical power supply to the dual-use vaporizer assembly, the user enjoys the vapor from heated tobacco wax or heated tobacco leaf.

### FIELD

The present disclosure generally relates to the field of electronic cigarettes, and more particularly to ceramic heating elements and dual-use electronic cigarettes having the ceramic heating elements.

### BACKGROUND

It is well known that smoking cigarette is harmful to smoker's health. The active ingredient in a cigarette is mainly nicotine. During smoking, nicotine, along with tar aerosol droplets produced in the cigarette burning, are breathed into the alveolus and absorbed quickly by the smoker. Once nicotine is absorbed into the blood of the smoker, nicotine then produced its effect on the receptors of the smoker's central nervous system, causing the smoker to relax and enjoy an inebriety similar to that produced by an exhilarant.

The electronic cigarette is sometimes referred as electronic vaporing device, personal vaporizer (PV), or electronic nicotine delivery system (ENDS). It is a battery-powered device which simulates tobacco smoking. It generally uses a heating element that vaporizes a liquid solution (E-liquid). Some solutions contain a mixture of nicotine and a variety of flavorings, while others release a flavored vapor without nicotine. Many are designed to simulate smoking experience, such as cigarette smoking or cigar smoking. Some of them are made with similar appearance, while others are made considerably different in appearance.

Conventional electronic cigarettes vaporize E-liquid to obtain the Electronic Cigarette Vapor, and the E-liquid is easy to spill during refill and may cause contamination. As alternatives to E-liquid, tobacco wax and tobacco leaf may be used to obtain electronic cigarette vapor. However, because the heating mechanism and heating temperatures are different, it requires different designs of the electronic cigarettes, one for using tobacco wax, and another for using tobacco leaf. For an electronic cigarette user who may enjoy both tobacco wax and tobacco leaf, in order to avoid high costs for having both tobacco wax electronic cigarette and tobacco leaf electronic cigarette, it is desirable to have a dual-use electronic cigarette that may use both tobacco wax and tobacco leaf.

Therefore, an unaddressed need exists in the art to address the aforementioned deficiencies and inadequacies.

### SUMMARY

In one aspect, the present disclosure relates to a heating plate. In certain embodiments, the heating plate includes a heating element, and a heater base. The heating element is formed in a zig-zag shape to cover entire surface of the heating plate. The heating element includes a positive terminal and a negative terminal for connecting the heating element to an external electrical power supply. The heater base is carved to form a matching zig-zag groove for fitting the heating element in the groove. When the positive terminal of the heating element is electrically coupled to a positive terminal of the external electrical power supply, and the negative terminal of the heating element is electrically coupled to a negative terminal of the external electrical power supply, and when the external electrical power supply is switched on, the heating element is energized by the external electrical power supply to heat tobacco wax over the heating plate to produce tobacco wax vapor for an electronic cigarette.

In one embodiment, the heating plate is a rectangular shaped heating plate. In another embodiment, the heating plate is a round shaped heating plate. In certain embodiments, the heating element is made of resistive electrical conductive materials having large contact area with the tobacco wax to increase amount of tobacco wax vapor generated. The heating element includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the heater base comprises ceramic, millipore materials, Graphene, thermal conductive silica film, and various thermal conductive insulation materials.

In certain embodiments, a bottom heater is formed by the heating plate. The bottom heater defines one or more air vents on its perimeter for providing air for vaporizing the tobacco wax. The bottom heater includes: a positive terminal for connecting the positive terminal of the heating element of the heating plate to the positive terminal of the external electrical power supply, a negative terminal for connecting the negative terminal of the heating element of the heating plate to the negative terminal of the external electrical power supply, and a bottom heating surface having the heating plate for vaporizing the tobacco wax from the bottom of the bottom heater.

In certain embodiments, the bottom heater includes a pair of parallel mounting surfaces for mounting the bottom heater on a vaporizer connector of the electronic cigarette such that the bottom heater is placed in the vaporizer connector in a predetermined direction to connect the positive terminal and the negative terminal of the bottom heater to the positive terminal and the negative terminal of the external electrical power supply, respectively.

In another aspect, the present disclosure relates to a heating tube. In certain embodiments, the heating tube includes: a cylindrical heating element, and a tubular heater base. The cylindrical heating element is formed in a zig-zag shape to cover entire surface of the heating tube. The cylindrical heating element includes a positive terminal and a negative terminal. The tubular heater base is carved to form a matching zig-zag groove for fitting the cylindrical heating element in the groove. When the positive terminal of the heating tube is electrically coupled to a positive terminal of an external electrical power supply, and the negative terminal of the heating tube is electrically coupled to a negative terminal of the external electrical power supply, and when the external electrical power supply is switched on, the cylindrical heating element is energized by the external electrical power supply to heat tobacco leaf to produce tobacco leaf vapor for an electronic cigarette.

In certain embodiments, the cylindrical heating element is made of resistive electrical conductive materials having large contact area with the tobacco leaf to increase amount of tobacco leaf vapor generated. In certain embodiments, the cylindrical heating element includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the tubular heater base comprises ceramic, millipore materials, Graphene, thermal conductive silica film, and various thermal conductive insulation materials.

In certain embodiments, a perimeter heater is formed by the heating tube. The perimeter heater defines one or more air vents on a bottom of the perimeter heater for providing air for heating the tobacco leaf. The perimeter heater includes: a positive terminal for connecting the positive terminal of the heating tube to the positive terminal of the external electrical power supply, a negative terminal for connecting the negative terminal of the heating tube to the negative terminal of the external electrical power supply, and a perimeter heating surface having the heating tube embedded therein for heating the tobacco leaf placed inside the perimeter heater.

In certain embodiments, the perimeter heater includes a pair of parallel mounting surfaces for mounting the perimeter heater on a vaporizer connector such that the perimeter heater is placed in the vaporizer connector in a predetermined direction to connect the positive terminal and the negative terminal of the perimeter heater to the positive terminal and the negative terminal of the external electrical power supply, respectively.

In yet another aspect, the present disclosure relates to a dual-use electronic cigarette. In certain embodiments, the dual-use electronic cigarette is used for a user to heat tobacco leaf and to vaporize tobacco wax. The dual-use electronic cigarette includes: a mouthpiece, and a dual-use vaporizer assembly. The mouthpiece is used for a user to enjoy the heated tobacco leaf and the vaporized tobacco wax. The dual-use vaporizer assembly includes a vaporizer upper body, a vaporizer middle body, a vaporizer power connector assembly, and a heater. The vaporizer upper body is connected to the mouthpiece. The vaporizer middle body connects to the vaporizer upper body through a vaporizer connector. The vaporizer power connector assembly connects to the vaporizer middle body through a first screw and a second screw from a top end of the vaporizer power connector assembly. The heater includes a bottom heater for vaporizing the tobacco wax, and a perimeter heater for heating the tobacco leaf. When the user places a predetermined amount of tobacco wax in the bottom heater or a predetermined amount of the tobacco leaf in the perimeter heater, places the corresponding heater into the dual-use vaporizer assembly, and connects the dual-use vaporizer assembly to an external electrical power supply, the user enjoys electronic cigarette vapor from the vaporized tobacco wax or the heated tobacco leaf.

In certain embodiments, the bottom heater defines one or more air vents on a perimeter of the bottom heater for providing air for vaporizing the tobacco wax. The bottom heater includes: a positive terminal for connecting a first power terminal of the external electrical power supply, a negative terminal for connecting a second power terminal of the external electrical power supply, and a bottom heating surface for vaporizing the tobacco wax from the bottom of the bottom heater.

In certain embodiments, the perimeter heater defines one or more air vents on a bottom surface of the perimeter heater for providing air for heating the tobacco leaf. The perimeter heater includes: a positive terminal for connecting a first power terminal of the external electrical power supply, a negative terminal for connecting a second power terminal of the external electrical power supply, and a perimeter heating surface for heating the tobacco leaf from the perimeter of the perimeter heater.

In certain embodiments, each of the bottom heater and the perimeter heater includes a pair of parallel mounting surface for mounting the bottom heater and the perimeter heater on the vaporizer connector such that the bottom heater is placed in the vaporizer connector in a predetermined direction to connect the positive terminal and the negative terminal of the bottom heater or the perimeter heater to the positive terminal and the negative terminal of the external electrical power supply, respectively.

In certain embodiments, each of the bottom heater and the perimeter heater includes: a heater base and a heating element. The heater base includes ceramic, millipore materials, Graphene, thermal conductive silica film, and various thermal conductive insulation materials. The heating element includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the mouthpiece includes a mouthpiece sealing ring. The mouthpiece is connected to the vaporizer upper body through the mouthpiece sealing ring to prevent vapor leaking from the mouthpiece.

In certain embodiments, the vaporizer upper body defines a vaporizer upper body connecting groove. The vaporizer middle body includes a vaporizer middle body locking block. When the user places the vaporizer upper body on the vaporizer middle body, the user turns the vaporizer upper body in a predetermined direction to lock the vaporizer upper body on the vaporizer middle body through the vaporizer middle body locking block and the vaporizer upper body connecting groove.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment. The drawings do not limit the present disclosure to the specific embodiments disclosed and described herein. The drawings are not necessarily to scale, emphasis instead being placed upon clearly illustrating the principles of the disclosure, and wherein:

FIG. 1 is a top perspective view of a heating element and a heater base of an exemplary heating plate according to certain embodiments of the present disclosure;

FIG. 2 is a top perspective view of the exemplary heating plate as shown in FIG. 1 according to certain embodiments of the present disclosure;

FIG. 3 is a top perspective view of a heating element and a heater base of another exemplary heating plate according to certain embodiments of the present disclosure;

FIG. 4 is a top perspective view of the exemplary heating plate as shown in FIG. 3 according to certain embodiments of the present disclosure;

FIG. 5 is a bottom perspective view of a bottom heater of a dual-use vaporizer assembly according to certain embodiments of the present disclosure;

FIG. 6 is a top perspective view of a heating element and a heater base of an exemplary heating tube according to certain embodiments of the present disclosure;

FIG. 7 is a top perspective view of the exemplary heating tube as shown in FIG. 6 according to certain embodiments of the present disclosure;

FIG. 8 is a bottom perspective view of a perimeter heater of the dual-use vaporizer assembly according to certain embodiments of the present disclosure;

FIG. 9 is a front view of an exemplary dual-use electronic cigarette having a dual-use vaporizer assembly according to certain embodiments of the present disclosure;

FIG. 10 is a perspective exploded view of the dual-use electronic cigarette having the dual-use vaporizer assembly according to certain embodiments of the present disclosure;

FIG. 11 is a sectional view of the dual-use electronic cigarette having the dual-use vaporizer assembly according to certain embodiments of the present disclosure;

FIG. 12 is a partial perspective exploded view of the dual-use vaporizer assembly with a ceramic heater detached according to certain embodiments of the present disclosure;

FIG. 13 is a sectional view of the dual-use electronic cigarette showing airflow through the dual-use vaporizer assembly having a bottom heater according to certain embodiments of the present disclosure; and

FIG. 14 is a sectional view of the dual-use electronic cigarette showing airflow through the dual-use vaporizer assembly having a perimeter heater according to certain embodiments of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

Many specific details are provided in the following descriptions to make the present disclosure be fully understood, but the present disclosure may also be implemented by using other manners different from those described herein, so that the present disclosure is not limited by the specific embodiments disclosed in the following.

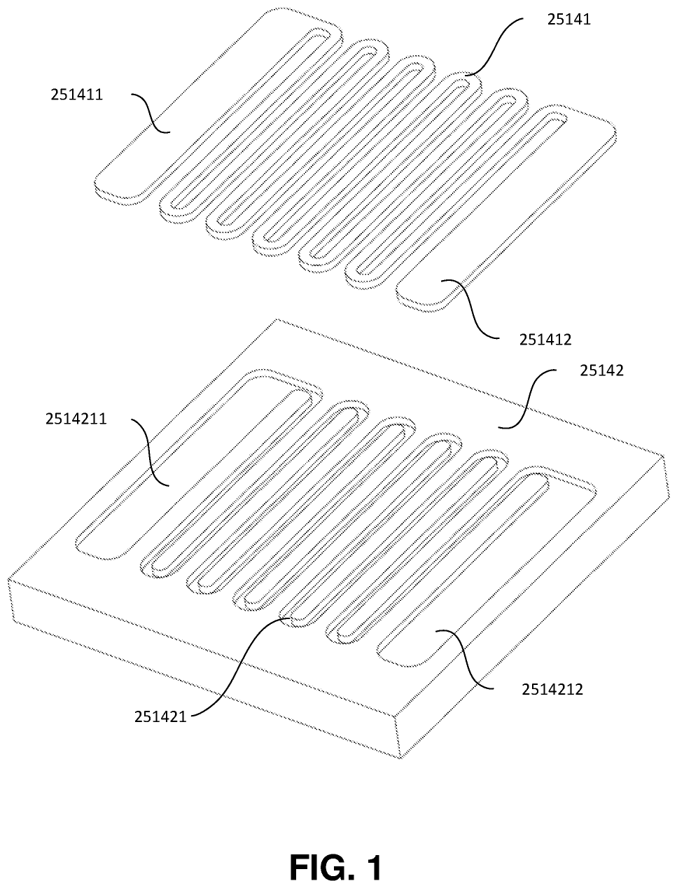

The description will be made as to the embodiments of the present disclosure in conjunction with the accompanying drawings FIGS. 1 through 14.

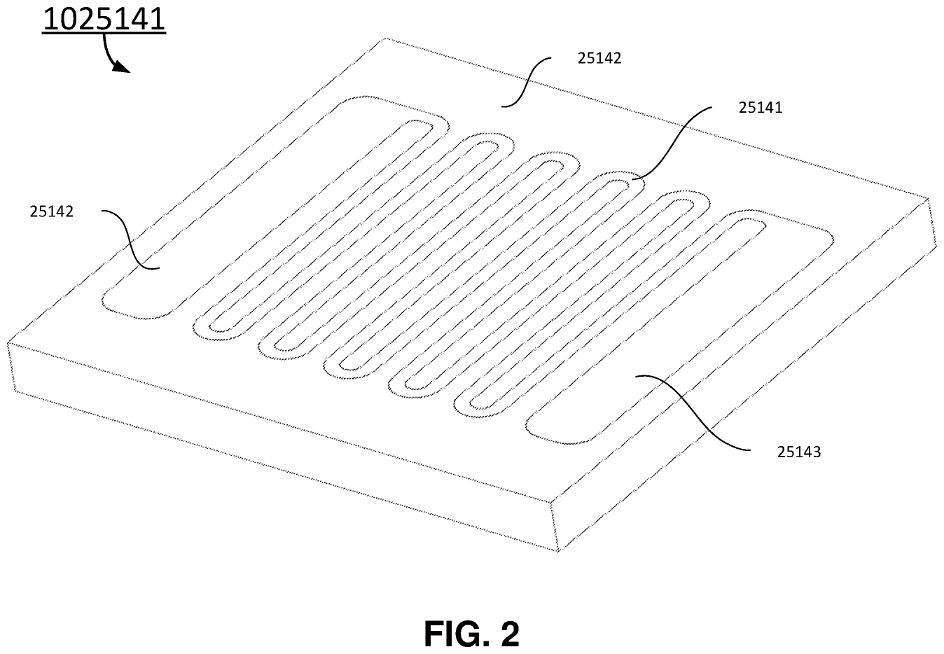

In one aspect, the present disclosure relates to a heating plate. In one embodiment, as shown in FIGS. 1 and 2, a rectangular heating plate 1025141 includes a heating element 25141, and a heater base 25142. The heating element 25141 is formed in a zig-zag shape to extend the length of the heating element 25141 to cover entire surface of the rectangular heating plate 1025141. The heating element 25141 includes a positive terminal 251411 and a negative terminal 251412 for connecting the heating element 25141 to an external electrical power supply. The heater base 25142 is carved to form a matching zig-zag groove 251421 for fitting the heating element 25141 in the groove 251421. The groove 251421 includes a positive terminal area 2514211 to fit the positive terminal 251411 of the heating element 25141, and a negative terminal area 25141212 to fit the negative terminal 251412 of the heating element 25141. The rectangular heating plate 1025141 is formed when the heating element 25141 is fitted into the heater base 25142. The top heating surface of the rectangular heating plate 1025141 is flush and smooth, as shown in FIG. 2.

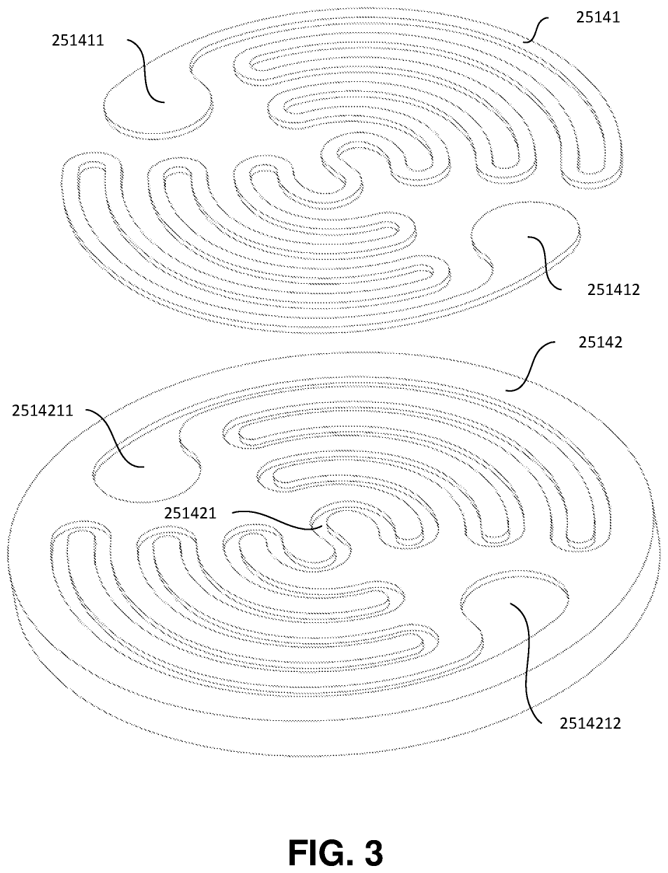

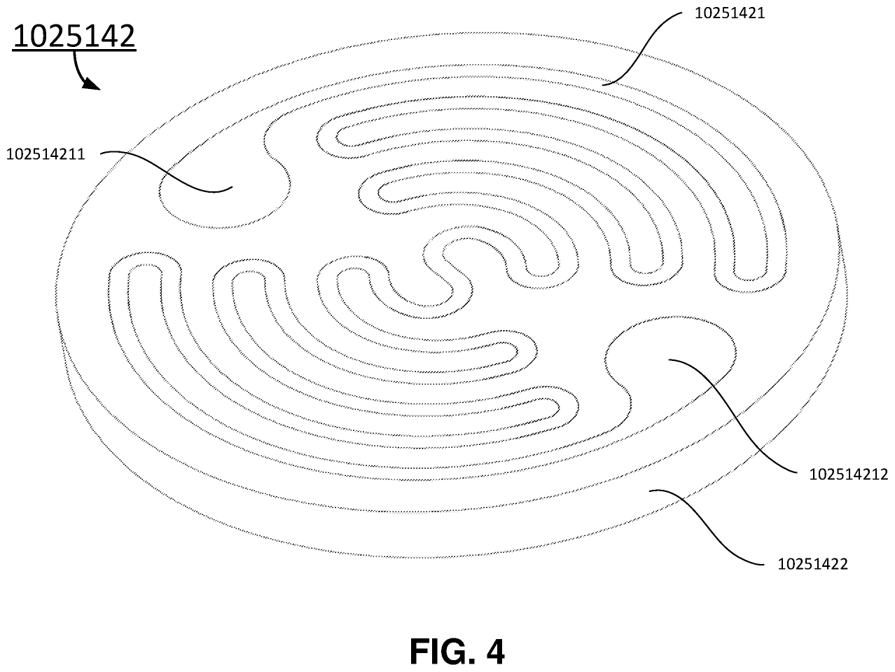

In another embodiment, as shown in FIGS. 3 and 4, a round heating plate 1025142 includes a heating element 25141, and a heater base 25142. The heating element 25141 is formed in a zig-zag shape to extend the length of the heating element 25141 to cover entire surface of the round heating plate 1025142. The heating element 25141 includes a positive terminal 251411 and a negative terminal 251412 for connecting the heating element 25141 to an external electrical power supply. The heater base 25142 is carved to form a matching zig-zag groove 251421 for fitting the heating element 25141 in the groove 251421. The groove 251421 includes a positive terminal area 2514211 to fit the positive terminal 251411 of the heating element 25141, and a negative terminal area 25141212 to fit the negative terminal 251412 of the heating element 25141. The round heating plate 1025142 is formed when the heating element 25141 is fitted into the heater base 25142. The top heating surface of the round heating plate 1025142 is flush and smooth, as shown in FIG. 4.

When the positive terminal 251411 of the heating element 25141 is electrically coupled to a positive terminal of the external electrical power supply, and the negative terminal 251412 of the heating element 25141 is electrically coupled to a negative terminal of the external electrical power supply, and when the external electrical power supply is switched on, the heating element 25141 is energized by the external electrical power supply to heat tobacco wax over the rectangular heating plate 1025141 or the round heating plate 1025142 to produce tobacco wax vapor for an electronic cigarette 10.

In certain embodiments, the heating element 25141 is made of resistive electrical conductive materials having large contact area with the tobacco wax to increase amount of tobacco wax vapor generated. In certain embodiments, the heating element 25141 includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the heater base 25142 is made of following materials: ceramic, millipore materials, Graphene, thermal conductive silica film, and various thermal conductive insulation materials.

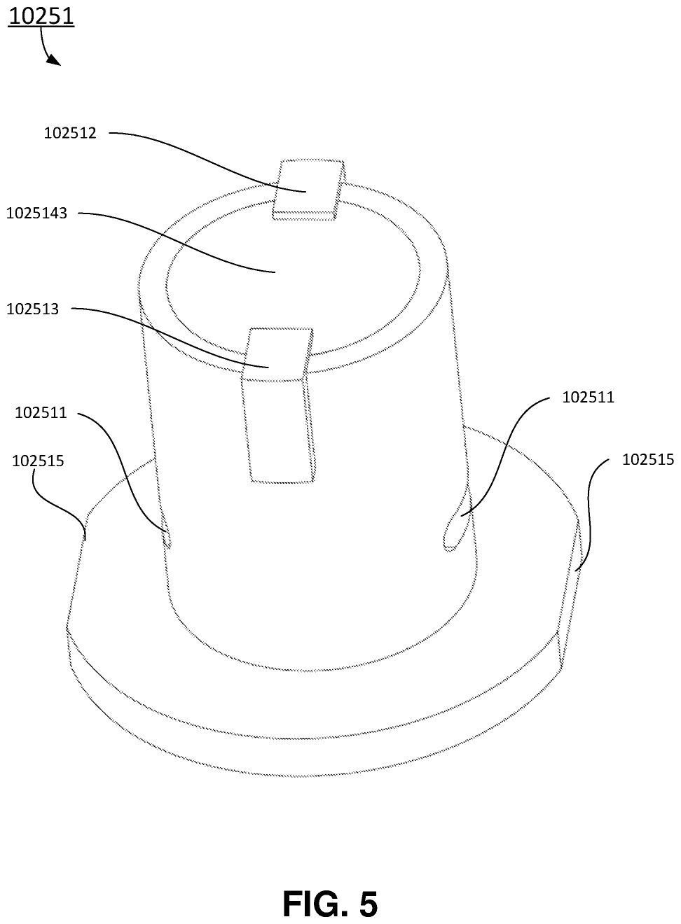

Referring now to FIG. 5, a bottom perspective view of a bottom heater 10251 for a dual-use vaporizer assembly 102 of an electronic cigarette 10 is shown according to certain embodiments of the present disclosure. The bottom heater 10251 defines one or more air vents 102511 on its perimeter for providing air for vaporizing the tobacco wax placed on the bottom heating surface 102514. The bottom heater 10251 includes: a positive terminal 102512 connected to the positive terminal 251411 of the heating element 25141, and a negative terminal 102513 connected to the negative terminal 251412 of the heating element 25141. The positive terminal 102512 of the bottom heater 10251 connects the positive terminal 251411 of the heating element 25141 to the positive terminal of the external electrical power supply, and the negative terminal 102512 of the bottom heater 10251 connects the negative terminal 251412 of the heating element 25141 to the negative terminal of the external electrical power supply. The bottom heating surface 1025143 of the bottom heater 10251 is formed by a rectangular heating plate 1025141 or a round heating plate 1025142, for vaporizing the tobacco wax placed on the bottom heating surface 102514 of the bottom heater 10251.

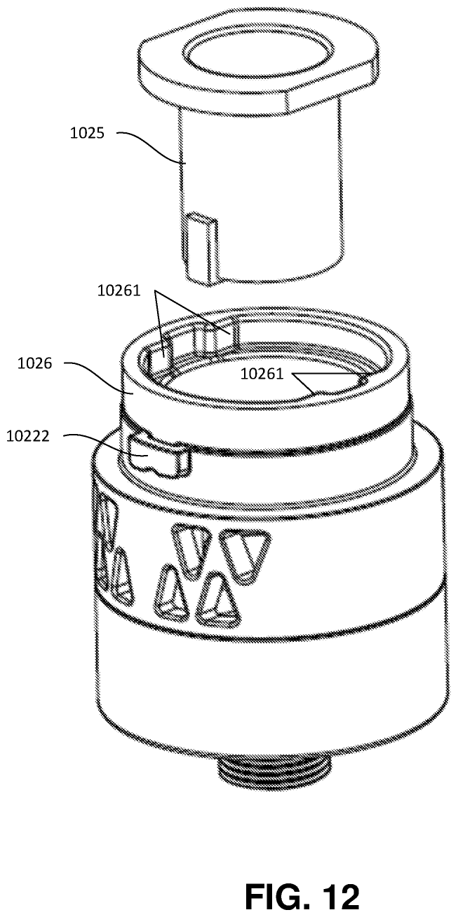

In certain embodiments, the bottom heater 10251 includes a pair of parallel mounting surfaces 102515 for mounting the bottom heater 10251 on a vaporizer connector 1024 of the electronic cigarette 10, as shown in FIG. 12, such that the bottom heater 10251 is placed in the vaporizer connector 1024 in a predetermined direction to connect the positive terminal 102512 of the bottom heater 10251 and the negative terminal 102512 of the bottom heater 10251 to the positive terminal and the negative terminal of the external electrical power supply, respectively.

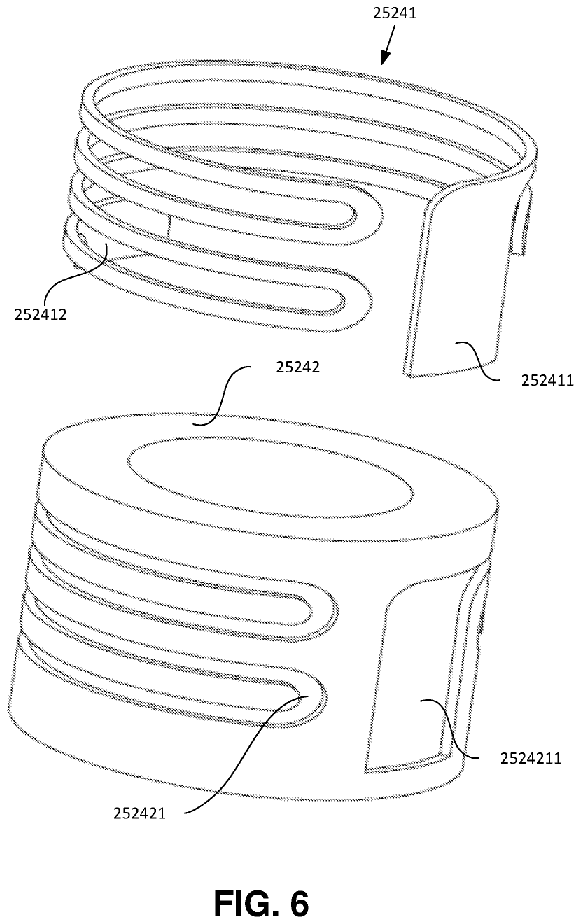

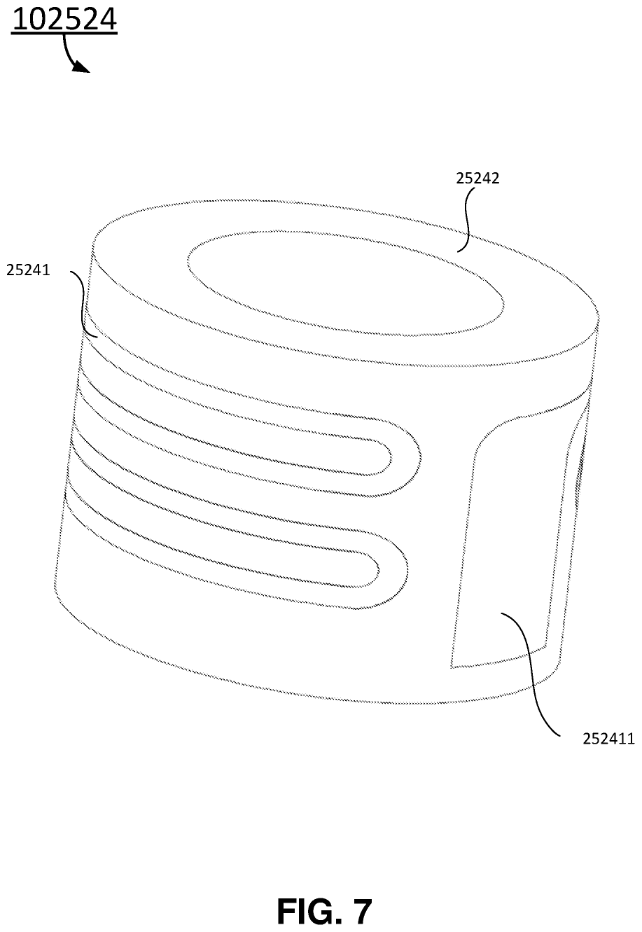

In another aspect, the present disclosure relates to a heating tube 102524, as shown in FIGS. 6 and 7. In certain embodiments, the heating tube 102524 includes: a cylindrical heating element 25241, and a heater base 25242. The cylindrical heating element 25241 is formed in a zig-zag shape to extend the length of the heating element 25241 to cover entire surface of the heating tube 102524. The cylindrical heating element 25241 includes a positive terminal 252411 and a negative terminal 252412 for connecting the cylindrical heating element 25241 to an external electrical power supply. The heater base 25242 is carved to form a matching zig-zag groove 252421 for fitting the cylindrical heating element 25241 in the groove 252421. The groove 252421 includes a positive terminal area 2524211 to fit the positive terminal 252411 of the cylindrical heating element 25241, and a negative terminal area 2524212 (not shown in FIGS. 6 and 7) to fit the negative terminal 252412 of the cylindrical heating element 25241. The heating tube 102524 is formed when the heating element 25141 is fitted into the heater base 25242. The tubular heating surface of the heating tube 102524 is flush and smooth, as shown in FIG. 7.

When the positive terminal 252411 of the heating tube 102524 is electrically coupled to a positive terminal of the external electrical power supply, and the negative terminal 252412 of the heating tube 102524 is electrically coupled to a negative terminal of the external electrical power supply, and when the external electrical power supply is switched on, the cylindrical heating element 25241 of the heating tube 102524 is energized by the external electrical power supply to heat the tobacco leaf placed in the heating tube 102524 to produce tobacco leaf vapor for an electronic cigarette 10.

In certain embodiments, the cylindrical heating element 25241 is made of resistive electrical conductive materials having large contact area with the tobacco wax to increase amount of tobacco wax vapor generated. In certain embodiments, the heating element 25141 includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the heater base 25242 is made of following materials: ceramic, millipore materials, Graphene, thermal conductive silica film, and various thermal conductive insulation materials.

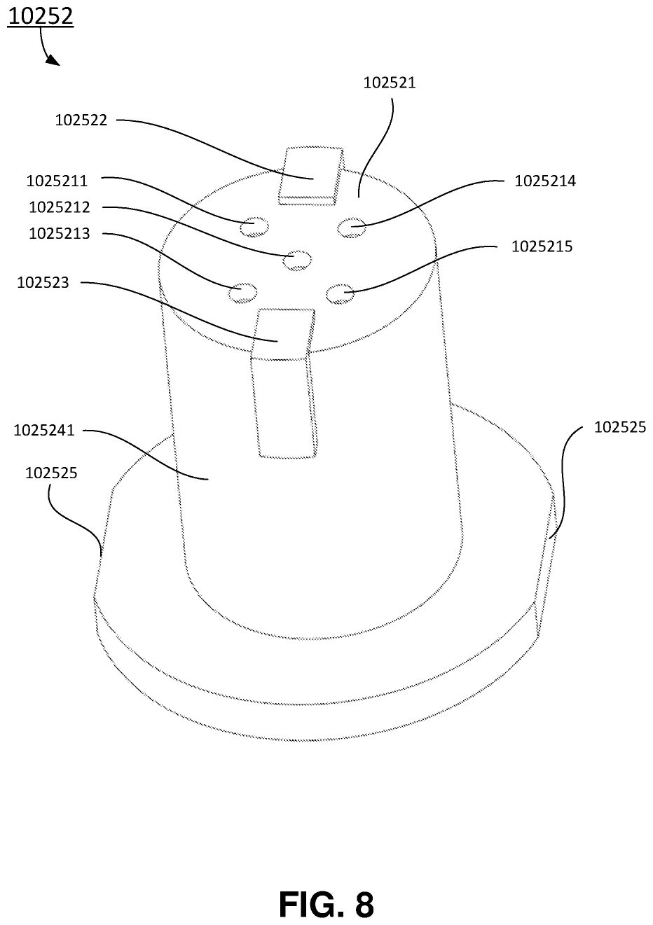

Referring now to FIG. 8, a bottom perspective view of a perimeter heater 10252 for a dual-use vaporizer assembly 102 of an electronic cigarette 10 is shown according to certain embodiments of the present disclosure. The perimeter heater 10252 defines one or more air vents 1025211, 1025212, 1025213, 1025214, and 1025215, on its bottom surface 102521 for providing air for heating the tobacco leaf placed on the bottom heating surface 102521. The perimeter heater 10252 includes: a positive terminal 102522 connected to the positive terminal 252411 of the cylindrical heating element 25241, and a negative terminal 102523 connected to the negative terminal 252412 of the cylindrical heating element 25241. The positive terminal 102522 of the perimeter heater 10252 connects the positive terminal 251411 of the heating element 25141 to the positive terminal of the external electrical power supply, and the negative terminal 102523 of the perimeter heater 10252 connects the negative terminal 252412 of the cylindrical heating element 25241 to the negative terminal of the external electrical power supply. The perimeter heating surface 1025241 of the perimeter heater 10252 is formed by a heating tube 102524 for heating the tobacco leaf placed inside of the heating tube 102524 of the perimeter heater 10252.

In certain embodiments, the perimeter heater 10252 includes a pair of parallel mounting surfaces 102525 for mounting the perimeter heater 10252 on a vaporizer connector 1024 of the electronic cigarette 10, as shown in FIG. 12, such that the perimeter heater 10252 is placed in the vaporizer connector 1024 in a predetermined direction to connect the positive terminal 102522 of the perimeter heater 10252 and the negative terminal 102523 of the perimeter heater 10252 to the positive terminal and the negative terminal of the external electrical power supply, respectively.

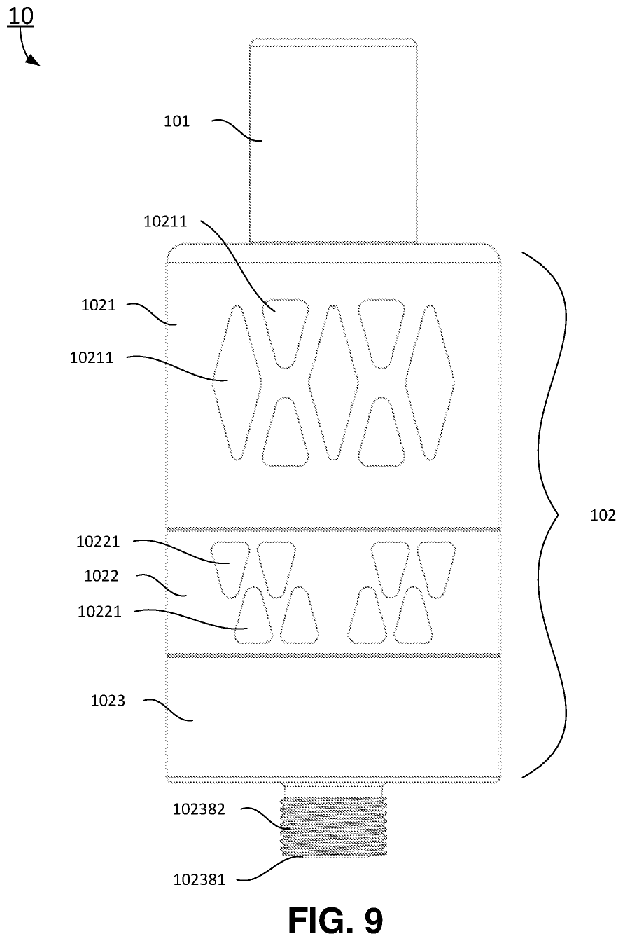

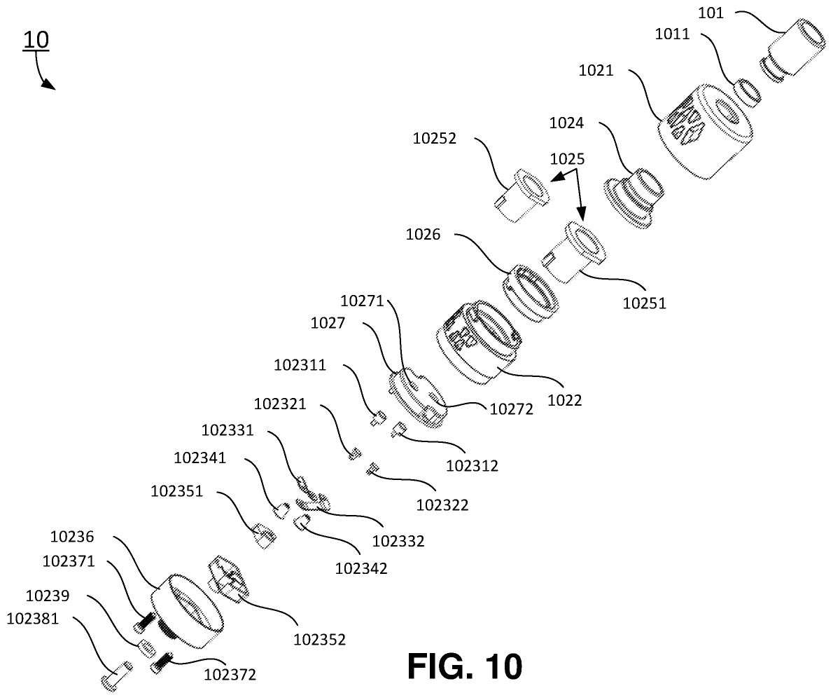

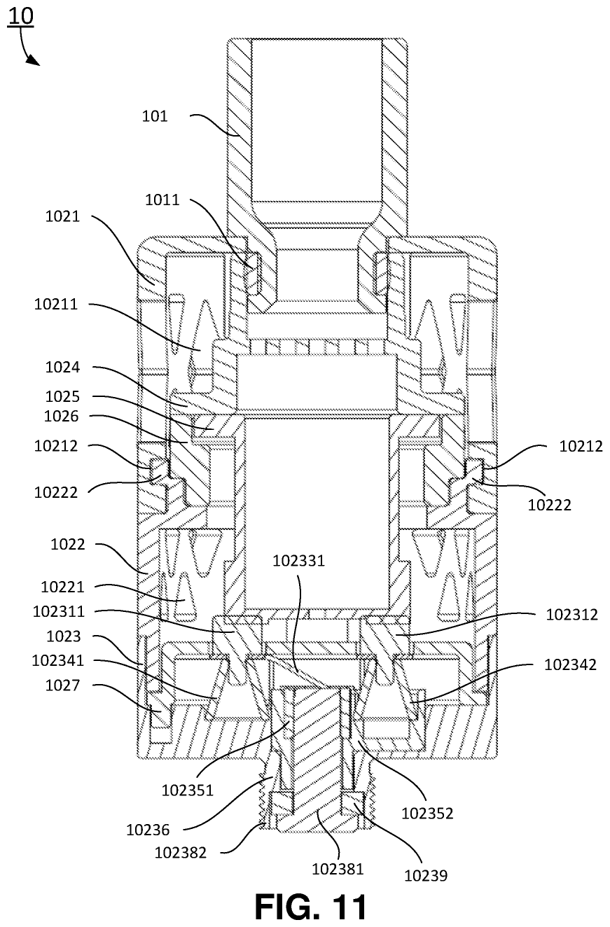

In yet another aspect, the present disclosure relates to a dual-use electronic cigarette 10 having a dual-use vaporizer assembly 102. FIG. 9 shows an external front view of an exemplary dual-use electronic cigarette 10 having the dual-use vaporizer assembly 102. In certain embodiments, the dual-use electronic cigarette 10 includes a mouthpiece 101, and a dual-use vaporizer assembly 102. The dual-use vaporizer assembly 102 includes a vaporizer upper body 1021, a vaporizer middle body 1022, and a vaporizer power connector assembly 1023. The vaporizer power connector assembly 1023 is connected to the vaporizer middle body through a first screw 102371 and a second screw 102372 from a top end of the vaporizer power connector assembly 1023. In certain embodiments, the mouthpiece 101 is attached to the vaporizer upper body 1021 at a top end of the dual-use electronic cigarette 10 and forms a vapor outlet for the dual-use vaporizer assembly 102. An electronic cigarette user enjoys electronic cigarette vapor generated by the dual-use vaporizer assembly 102 through the mouthpiece 101. As shown in FIGS. 10 and 11, the mouthpiece 101 is attached to the vaporizer upper body 1021 through a mouthpiece sealing ring 1011 to prevent the vapor from leaking out of the dual-use vaporizer assembly 102.

As shown in FIG. 10, a heater 1025 is installed inside the vaporizer upper body 1021 and the vaporizer middle body 1022 of the dual-use electronic cigarette 10. The heater 1025 is mounted through a vaporizer support ring 1026 in the vaporizer middle body 1022. The upper part of the heater 1025 is connected by a vaporizer connector 1024 with the vaporizer upper body 1021 having the mouthpiece 101 installed.

In certain embodiments, the heater 1025 includes one of a bottom heater 10251 and a perimeter heater 10252. The bottom heater 10251 is used to heat and vaporize tobacco wax and to obtain tobacco wax vapor. The perimeter heater 10252 is used to heat and vaporize tobacco leaf and to obtain tobacco leaf vapor. The dual-use vaporizer assembly 102 has enough space to install one of the bottom heater 10251 and the perimeter heater 10252. The bottom heater 10251 and the perimeter heater 10252 are interchangeable, either one of the bottom heater 10251 and the perimeter heater 10252 may be installed according to the user's intended purpose. When the user decides to use tobacco wax, the bottom heater 10251 is installed into the dual-use vaporizer assembly 102. When the user decides to use tobacco leaf, the perimeter heater 10252 is installed into the dual-use vaporizer assembly 102.

As shown in FIGS. 9 and 10, in certain embodiments, the vaporizer upper body 1021 defines a set of heat radiation openings 10211. These heat radiation openings 10211 are used to emit heat generated from the dual-use vaporizer assembly 102. The vaporizer middle body 1022 defines a set of air intake openings 10221. These air intake openings 10221 are used to provide air from outside of the dual-use electronic cigarette 10 to the dual-use vaporizer assembly 102.

In certain embodiments, the vaporizer power connector assembly 1023 includes a positive power terminal 102381 and a negative power terminal 102382, as shown in FIG. 9. In one embodiment, the positive power terminal 102381 and the negative power terminal 102382 form a threaded connector on a power connector base 10236, as shown in FIGS. 9 and 10. The center portion of the threaded connector forms the positive power terminal 102381, and the outside portion of the threaded connector forms the negative power terminal 102382. The external electrical power supply may be connected to the vaporizer power connector assembly 1023 through other connectors including: a T-shaped groove connector, a dovetail shaped slot connector, a magnetic attachment connector, and a multi-threaded connector.

In certain embodiments, a lower end of the vaporizer upper body 1021 is connected to a top end of the vaporizer middle body 1022 through a vaporizer upper body connecting mechanism. As shown in FIG. 11, the vaporizer upper body connecting mechanism includes at least two vaporizer upper body connecting grooves 10212 of the vaporizer upper body 1021, one on each side, and at least two vaporizer middle body locking blocks 10222, also one on each side in matching positions with the vaporizer upper body connecting grooves 10212. In certain embodiments, each of the vaporizer upper body connecting grooves 10212 is in an “L” shape, with a vertical groove and a horizontal groove. The vaporizer middle body locking blocks 10222 are inserted down into the vertical grooves. When the user twists the vaporizer upper body 1021 against the vaporizer middle body 1022 along the direction of the horizontal groove, the vaporizer upper body 1021 is locked and attached to the vaporizer middle body 1022. The vaporizer upper body connecting mechanism allows the user to open and detach the vaporizer upper body 1021 from the vaporizer middle body 1022 and to replace one or more heaters inside the dual-use vaporizer assembly 102. When the user desires to replace the bottom heater 10251 with the perimeter heater 10252, or vice versa, the user can easily twist the vaporizer upper body 1021 and move the vaporizer upper body 1021 upward to detach the vaporizer upper body 1021 from the vaporizer middle body 1022.

In certain embodiments, when the user connects the dual-use vaporizer assembly 102 to the external electrical power supply (not shown in FIGS. 1-14) and a predetermined amount of the tobacco wax is placed in the bottom heater 10251, the bottom heater 10251 vaporizes the tobacco wax to provide tobacco wax vapor for the user. When a predetermined amount of the tobacco leaf is placed in the perimeter heater 10252, the perimeter heater 10252 heats the tobacco leaf to provide tobacco leaf vapor for the user.

In certain embodiments, each of the bottom heater 10251 and the perimeter heater 10252 may include a heater base and a heating element as shown in FIGS. 1-8. The heater base of the bottom heater 10251 and the perimeter heater 10252 are made of materials that can insulate the electric current and conduct heat. In certain embodiments, these materials include ceramic, millipore materials, Graphene, thermal conductive silica film, and various thermal conductive insulation materials. The heating element is embedded in the heater base. The heating element may include: a grid shaped heating element, a mesh shaped heating element, a net shaped heating element, a spiral heating element; and any combination these heating elements. The heating element includes: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Jr), Platinum (Pt), Gold (Au), and alloys of these materials.

In certain embodiments, the bottom heater 10251 and the perimeter heater 10252 are designed to be able to increase the temperature of the bottom heater 10251 and the perimeter heater 10252 in a very rapid speed. In one embodiment, the bottom heater 10251 and the perimeter heater 10252 can raise the temperature to 200 ° F. in less then 10 seconds. Such a quick temperature increase and maintaining at such high temperature allows the dual-use electronic cigarette 10 to produce large quantity of tobacco wax vapor or tobacco leaf vapor. In order to ensure safety and avoid burn to the user, the vaporizer upper body 1021 has a set of heat radiation openings 10211 to dissipate the heat generated by the bottom heater 10251 or the perimeter heater 10252. The dual-use vaporizer assembly 102 should be made with materials that can sustain high temperature such as ceramic and other materials having high thermal conductivity.

In certain embodiments, as shown in FIG. 10, the vaporizer power connector assembly 1023 includes: a power connector base 10236, a connecting spring base 102351, a power insulator 102352, and a vaporizer power insulator 1027. The vaporizer power connector assembly 1023 includes a first power terminal connector 102311 and a second power terminal connector 102312. The first power terminal connector 102311 and the second power terminal connector 102312 are positioned through a first power terminal hole 10271 and a second power terminal hole 10272 of the vaporizer power insulator 1027, to connect the external electrical power supply to the positive terminal 102512 and the negative terminal 102513 of the bottom heater 10251 or the positive terminal 102522 and the negative terminal 102523 of the perimeter heater 10252, respectively.

The first power terminal connector 102311 is attached to a first connecting spring 102331 and a first connecting spring support 102341 on the connecting spring base 102351 and the power insulator 102352 through a first fastener pin 102321. The second power terminal connector 102312 is attached to a second connecting spring 102332 and a second connecting spring support 102342 on the connecting spring base 102351 and the power insulator 102352 through a second fastener pin 102322. In one embodiment, the first connecting spring 102331 connects to the positive power terminal 102381 and the second connecting spring 102332 connects to the negative power terminal 102382. The positive power terminal 102381 and the negative power terminal 102382 are insulated by a positive power insulator ring 10239.

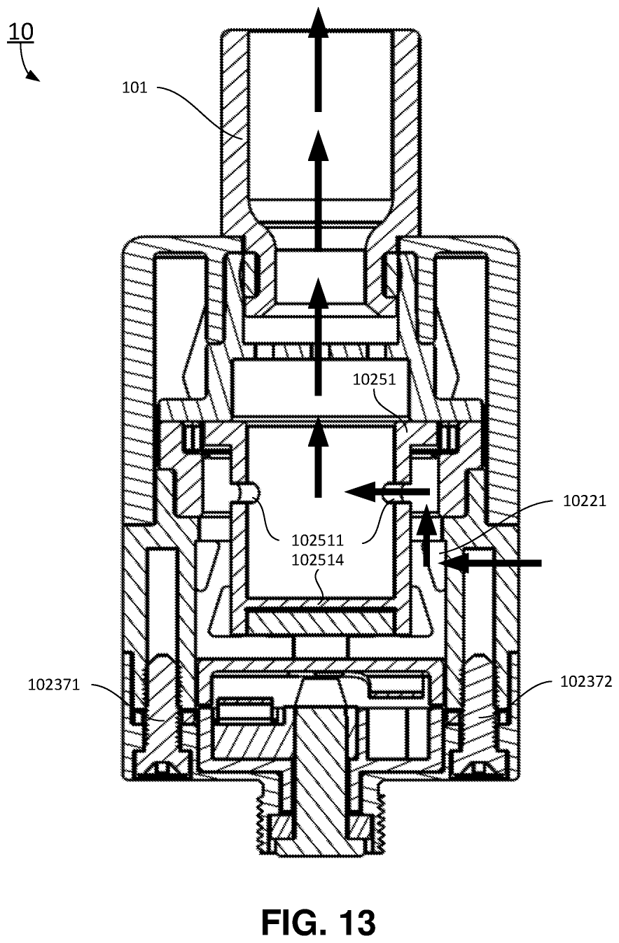

In one embodiment, when the bottom heater 10251 is placed inside the dual-use vaporizer assembly 102, the outside air enters the dual-use vaporizer assembly 102 though the vaporizer air intake openings 10221 on either side of the vaporizer middle body 1022, goes up towards the air vents 102511 of the bottom heater 10251, and meets the tobacco wax placed inside the bottom heater 10251. The vaporized tobacco wax then goes up through the vaporizer connector 1024 towards the mouthpiece 101 for the user to enjoy, as shown by the arrows in FIG. 13.

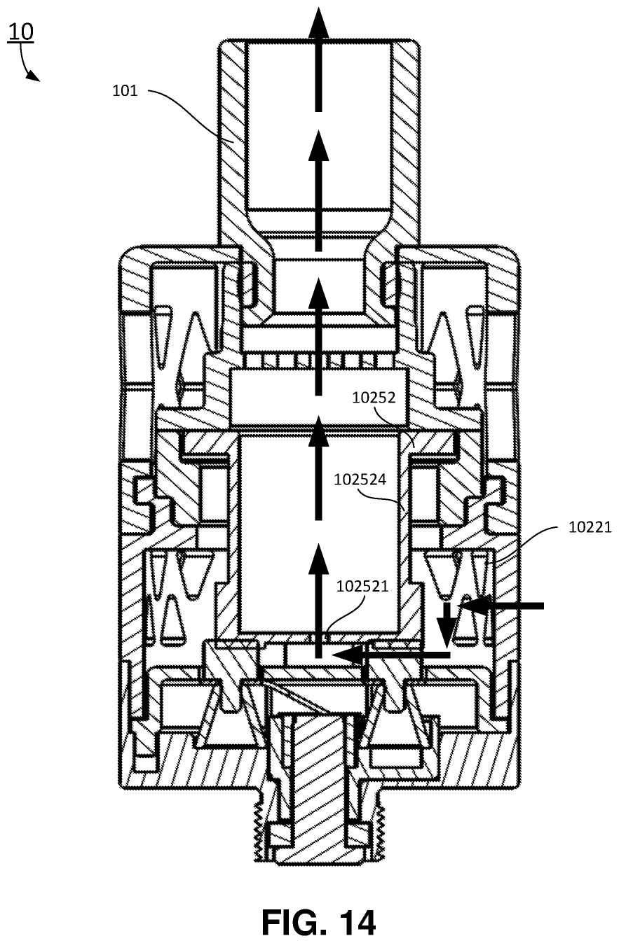

In another embodiment, when the perimeter heater 10252 is placed inside the dual-use vaporizer assembly 102, the outside air enters the dual-use vaporizer assembly 102 though the vaporizer air intake openings 10221 on either side of the vaporizer middle body 1022, goes down towards the air vents 102521 of the perimeter heater 10252, and meets the tobacco leaf placed inside the perimeter heater 10252. The vaporized tobacco leaf then goes up through the vaporizer connector 1024 towards the mouthpiece 101 for the user to enjoy, as shown by the arrows in FIG. 14.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims, the foregoing description and the exemplary embodiments described therein, and accompanying drawings.

What is claimed is:

1. A heating plate, comprising:
a heating element having a zig-zag shape to cover entire surface of the heating plate, wherein the heating element comprises a positive terminal and a negative terminal; and
a heater base having a matching zig-zag groove carved into the heater base for fitting the heating element in the groove,
wherein the positive terminal is electrically coupled to a positive terminal of an external electrical power supply, and the negative terminal is electrically coupled to a negative terminal of the external electrical power supply, when the external electrical power supply is switched on, the heating element is energized by the external electrical power supply to heat tobacco wax over the heating plate to produce tobacco wax vapor for an electronic cigarette.

2. The heating plate of claim 1, wherein the heating plate comprises: a rectangular shape heating plate, and a round shape heating plate.

3. The heating plate of claim 1, wherein the heating element is made of resistive electrical conductive materials having large contact area with the tobacco wax to increase amount of tobacco wax vapor generated, and wherein the heating element comprises: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Ir), Platinum (Pt), Gold (Au), and alloys thereof.

4. The heating plate of claim 1, wherein the heater base comprises ceramic, millipore materials, Graphene, thermal conductive silica film, and various thermal conductive insulation materials.

5. A bottom heater comprising the heating plate of claim 1, wherein the bottom heater defines one or more air vents on a perimeter of the bottom heater for providing air for vaporizing the tobacco wax, and the bottom heater comprises:
a positive terminal for connecting the positive terminal of the heating element of the heating plate to the positive terminal of the external electrical power supply;
a negative terminal for connecting the negative terminal of the heating element of the heating plate to the negative terminal of the external electrical power supply; and
a bottom heating surface having the heating plate for vaporizing the tobacco wax from the bottom of the bottom heater.

6. The bottom heater of claim 5, wherein the bottom heater comprises a pair of parallel mounting surfaces for mounting the bottom heater on a vaporizer connector of the electronic cigarette such that the bottom heater is placed in the vaporizer connector in a predetermined direction to connect the positive terminal and the negative terminal of the bottom heater to the positive terminal and the negative terminal of the external electrical power supply, respectively.

7. A heating tube, comprising:
a cylindrical heating element having a zig-zag shape to cover entire surface of the heating tube, wherein the cylindrical heating element comprises a positive terminal and a negative terminal; and
a tubular heater base carved in a matching zig-zag groove for fitting the cylindrical heating element in the groove,
wherein the positive terminal is electrically coupled to a positive terminal of an external electrical power supply, and the negative terminal is electrically coupled to a negative terminal of the external electrical power supply, when the external electrical power supply is switched on, the heating element is energized by the external electrical power supply to heat tobacco leaf to produce tobacco leaf vapor for an electronic cigarette.

8. The heating tube of claim 7, wherein the cylindrical heating element is made of resistive electrical conductive materials having large contact area with the tobacco leaf to increase amount of tobacco leaf vapor generated, and wherein the cylindrical heating element comprises: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Ir), Platinum (Pt), Gold (Au), and alloys thereof.

9. The heating plate of claim 7, wherein the tubular heater base comprises ceramic, millipore materials, Graphene, thermal conductive silica film, and various thermal conductive insulation materials.

10. A perimeter heater comprising the heating tube of claim 7, wherein the perimeter heater defines one or more air vents on a bottom of the perimeter heater for providing air for heating the tobacco leaf, and the perimeter heater comprises:
a positive terminal for connecting the positive terminal of the heating tube to the positive terminal of the external electrical power supply;
a negative terminal for connecting the negative terminal of the heating tube to the negative terminal of the external electrical power supply; and
a perimeter heating surface having the heating tube embedded therein for heating the tobacco leaf placed over the bottom of the perimeter heater.

11. The perimeter heater of claim 10, wherein the perimeter heater comprises a pair of parallel mounting surfaces for mounting the perimeter heater on a vaporizer connector such that the perimeter heater is placed in the vaporizer connector in a predetermined direction to connect the positive terminal and the negative terminal of the perimeter heater to the positive terminal and the negative terminal of the external electrical power supply, respectively.

12. A dual-use electronic cigarette, comprising:
a mouthpiece for a user to enjoy heated tobacco leaf and vaporized tobacco wax;
a dual-use vaporizer assembly having
a vaporizer upper body connected to the mouthpiece;
a vaporizer middle body connected to the vaporizer upper body through a vaporizer connector;
a vaporizer power connector assembly connected to the vaporizer middle body through a first screw and a second screw from a top end of the vaporizer power connector assembly; and
a heater, wherein the heater comprises a bottom heater for vaporizing the tobacco wax and a perimeter heater for heating the tobacco leaf,
wherein when a user places a predetermined amount of tobacco wax in the bottom heater or a predetermined amount of the tobacco leaf in the perimeter heater, places the corresponding heater into the dual-use vaporizer assembly, and connects the dual-use vaporizer assembly to an external electrical power supply, the user enjoys electronic cigarette vapor from the vaporized tobacco wax or the heated tobacco leaf.

13. The dual-use electronic cigarette of claim 12, wherein the bottom heater defines one or more air vents on a perimeter of the bottom heater for providing air for vaporizing the tobacco wax, and the bottom heater comprises:
a positive terminal for connecting a first power terminal of the external electrical power supply;
a negative terminal for connecting a second power terminal of the external electrical power supply; and
a bottom heating surface for vaporizing the tobacco wax from the bottom of the bottom heater.

14. The dual-use electronic cigarette of claim 13, wherein the bottom heater comprises a pair of parallel mounting surface for mounting the bottom heater on the vaporizer connector such that the bottom heater is placed in the vaporizer connector in a predetermined direction to connect the positive terminal and the negative terminal to the external electrical power supply.

15. The dual-use electronic cigarette of claim 12, wherein the perimeter heater defines one or more air vents on a bottom surface of the perimeter heater for providing air for heating the tobacco leaf, and the perimeter heater comprises;
a positive terminal for connecting a first power terminal of the external electrical power supply;
a negative terminal for connecting a second power terminal of the external electrical power supply; and
a perimeter heating surface for heating the tobacco leaf from the perimeter of the perimeter heater.

16. The dual-use electronic cigarette of claim 15, wherein the perimeter heater comprises a pair of parallel mounting surface for mounting the perimeter heater on the vaporizer connector such that the perimeter heater is placed in the vaporizer connector in a predetermined direction to connect the positive terminal and the negative terminal to the external electrical power supply.

17. The dual-use electronic cigarette of claim 12, wherein each of the bottom heater and the perimeter heater comprises:
a heater base, wherein the heater base comprises ceramic, millipore materials, Graphene, thermal conductive silica film, and various thermal conductive insulation materials; and
a heating element made of resistive electrical conductive materials.

18. The dual-use electronic cigarette of claim 17, wherein the heating element comprises: aluminum (Al), Chromium(Cr), Manganese (Mn), Iron (Fe), Cobalt (Co), Nickel (Ni), Copper (Cu), Zirconium (Zr), Niobium (Nb), Molybdenur (Mo), Rhenium (Re), Silver (Ag), Cadmium(Cd), Tantalum (Ta), Tungsten (W), Iridium (Ir), Platinum (Pt), Gold (Au), and alloys of these materials.

19. The dual-use electronic cigarette of claim 12, wherein the mouthpiece comprises a mouthpiece sealing ring, wherein the mouthpiece is connected to the vaporizer upper body through the mouthpiece sealing ring to prevent vapor leaking from the mouthpiece.

20. The dual-use electronic cigarette of claim 12, wherein the vaporizer upper body defines a vaporizer upper body connecting groove, the vaporizer middle body includes a vaporizer middle body locking block, and when the user places the vaporizer upper body on the vaporizer middle body, the user turns the vaporizer upper body in a predetermined direction to lock the vaporizer upper body on the vaporizer middle body through the vaporizer middle body locking block and the vaporizer upper body connecting groove.
